(19) United States
(12) Patent Application Publication
(10) Pub. No.: US 2026/0184930 A1
(43) Pub. Date: Jul. 2, 2026

(54) LOW-TEMPERATURE AND HIGH-HUMIDITY RESISTANT PRIMER FOR SILICONE SEALANT, AND PREPARATION METHOD THEREFOR

(71) Applicants: GUANGZHOU BAIYUN TECHNOLOGY CO., LTD., Guangdong (CN); GUANGDONG BAIYUN TECHNOLOGY CO., LTD., Guangdong (CN)

(72) Inventors: Mujie LI, Guangdong (CN); Jinbo JIANG, Guangdong (CN); Ping ZHOU, Guangdong (CN); Rong ZENG, Guangdong (CN); Wenjun LIU, Guangdong (CN); Jialing GUO, Guangdong (CN)

(73) Assignees: GUANGZHOU BAIYUN TECHNOLOGY CO., LTD., Guangdong (CN); GUANGDONG BAIYUN TECHNOLOGY CO., LTD., Guangdong (CN)

(21) Appl. No.: 19/546,450

(22) Filed: Feb. 23, 2026

Related U.S. Application Data
(63) Continuation of application No. PCT/CN2023/140647, filed on Dec. 21, 2023.

(30) Foreign Application Priority Data
Aug. 25, 2023 (CN) 202311080377.8

(51) Int. Cl. C09D 5/00; C09D 7/20; C09D 7/63

(52) U.S. Cl. CPC C09D 5/002; C09D 7/20; C09D 7/63

(57) ABSTRACT

Disclosed in the present disclosure are a modified silane coupling agent, a low-temperature and high-humidity resistant primer for a silicone sealant, and a preparation method therefor. The modified silane coupling agent is obtained by a dealcoholization cyclization reaction of bis(allyl-dialkoxysilylpropyl) amine under the action of a catalyst, the bis(allyl-dialkoxysilylpropyl) amine is obtained by an amino substitution reaction of allyl chloropropyl dialkoxysilane and liquid ammonia, and the allyl chloropropyl dialkoxysilane is obtained by an alcohol substitution reaction between allyl chloropropyl dichlorosilane and a short-chain alcohol. The structure of the modified silane coupling agent contains nitrogen heterocyclic rings, and in a high-humidity environment, the nitrogen heterocyclic rings are easily hydrolyzed, to form secondary amino silanes and to consume part of water on surfaces of the base materials. In addition, the secondary amine groups are capable of promoting hydrolysis of siloxane into a plurality of silanols and a rapid reaction capacity is achieved.

### CROSS-REFERENCE TO RELATED APPLICATIONS

This application is a continuation of international application of PCT application serial no. PCT/CN2023/140647, filed on Dec. 21, 2023, which claims the priority benefit of China application serial no. 202311080377.8, filed on Aug. 15, 2023. The entirety of each of the above-mentioned patent application is hereby incorporated by reference herein and made a part of this specification.

### BACKGROUND

### Technical Field

The present disclosure relates to the field of sealant, particularly to low-temperature and high-humidity resistant primer for silicone sealant, and preparation method therefor.

### Description of Related Art

Silicone sealants possess excellent features, such as weather resistance, aging resistance, good sealing performance, and ease of application and maintenance. They are important raw materials in the construction field for achieving adhesive between most building materials and widely used in building curtain walls, insulated glass, energy-saving doors and windows, prefabricated buildings, decoration and renovation, etc.

The adhesive of silicone sealant to substrate is related to both the formulation system of the silicone sealant and the environmental factors such as temperature and humidity during application. Under low-temperature, the wettability of silicone sealant on the substrate surface decreases. In high-humidity environments, the waterproof adhesive of the sealant is poor, leading to reduced adhesive to certain substrates, such as those treaded with special surface treatments, like powder spraying and fluorocarbon spraying. In this situation, it is often necessary to improve interfacial adhesive by applying a primer to the substrate surface. Silicone sealant primers can significantly improve the adhesive between silicone sealants and substrates, but it is easily affected by environmental factors in practical applications. In low-temperature and high-humidity environments, the reaction activity of the primer decreases, resulting in a slower initial bonding speed; in addition, the primer is prone to hydrolysis and failure when in contact with mist or frost on the surface of the substrate, and the poor compatibility between organic solvents and water leads to uneven film formation, localized non-adhesive, and other problems that affect the overall adhesive.

Patent No. CN113402695A discloses a low-temperature and high-humidity resistant water-based polyurethane resin, prepared by reacting hydroxyl terminated polybutadiene, castor oil modified polyester polyol, and isophorone diisocyanate. It forms an interpenetrating network structure through the reaction of hydroxyl-terminated polybutadiene, castor oil-modified polyester polyol, and isophorone diisocyanate. After film formation, it exhibits good low-temperature and high-humidity resistance. However, the preparation process is complicated and it requires one week of curing for good adhesive properties, and the initial adhesive is not significantly improved.

Therefore, it is particularly important to provide a silicone sealant primer that addresses the problems of existing silicone sealant primers, that not only meets the performance requirements of existing silicone sealant primers, but also maintains high adhesive in extreme environments of low-temperature and high-humidity. Such a primer would have significant practical value.

### SUMMARY

Based on this, the present disclosure provides a modified silane coupling agent, which is used to prepare a silicone sealant primer. It maintains high reactivity at low-temperatures, has good initial adhesive, and can quickly form a film in high-humidity environments, resulting in good water-resistant adhesive.

The first aspect of the present disclosure provides a modified silane coupling agent, with following structural formula:

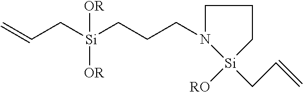

wherein, R is C1 to C4 alkyl.

The second aspect of the present disclosure provides a modified silane coupling agent, being prepared through a dealcoholization and cyclization reaction of bis(allyl-dialkoxysilylpropy) amine under the action of a catalyst, wherein the bis(allyl-dialkoxysilylpropy) amine is obtained through an amino substitution reaction between allyl chloropropyl dialkoxysilane and liquid ammonia, and the allyl chloropropyl dialkoxysilane is obtained through an alcohol substitution reaction between allyl chloropropyl dichlorosilane and short-chain alcohol.

In some embodiments, the catalyst consists of metallic nickel and an organic base in a mass ratio of (8 to 22):1, wherein the organic base is preferably sodium ethoxide.

In some embodiments, the short-chain alcohol is selected from C1 to C4 saturated fatty alcohols, preferably methanol or ethanol.

In some embodiments, the molar ratio of allyl chloropropyl dichlorosilane to short-chain alcohol is 1:(2 to 5), preferably 1:(3 to 3.8).

In some embodiments, the molar ratio of allyl chloropropyl dialkoxysilane to liquid ammonia is 1:(0.5 to 3), preferably 1:(0.5 to 1).

In some embodiments, the mass ratio of the catalyst to the bis(allyl-dialkoxysilylpropy) amine is (0.001 to 0.01):1, preferably (0.0017 to 0.007):1.

The third aspect of the present disclosure provides a method for preparing a modified silane coupling agent, comprising the following steps:
(1) mix allyl chloropropyl dichlorosilane with a short-chain alcohol, heat to 70° C. to 90° C. and reflux for 1 h to 2 h to obtain allyl chloropropyl dialkoxysilane;
(2) mix the allyl chloropropyl dialkoxysilane with liquid ammonia, introduce an inert gas, and conduct a reflux reaction under constant temperature at 60° C. to 70° C. for 1 h to 2 h to obtain bis(allyl-dialkoxysilylpropyl) amine;
(3) add a catalyst to the bis(allyl-dialkoxysilylpropyl) amine and react at 70° C. to 80° C. for 2.5 h to 3.5 h to obtain a modified silane coupling agent.

The fourth aspect of the present disclosure provides a silicone sealant primer, comprising the modified silane coupling agent.

In some embodiments, the silicone sealant primer comprises following raw materials in parts by weight:

| | |
|---|---|
| modified silane coupling agent, | 30 to 145 parts |
| adhesive promoter | 7 to 28 parts, |
| adhesive catalyst | 10 to 76 parts, |
| solvent | 70 to 168 parts. |

In some embodiments, the silicone sealant primer comprises following raw materials in parts by weight:

| | |
|---|---|
| modified silane coupling agent | 60 to 78 parts, |
| adhesive promoter | 12 to 20 parts, |
| adhesive catalyst | 15 to 40 parts, |
| solvent | 90 to 140 parts. |

In some embodiments, the silicone sealant primer comprises following raw materials in parts by weight:

| | |
|---|---|
| modified silane coupling agent | 60 to 64 parts, |
| adhesive promoter | 12 to 16 parts, |
| adhesive catalyst | 18 to 22 parts, |
| solvent | 88 to 92 parts. |

In some embodiments, the adhesive promoter is selected from at least one of methyltrimethoxysilane and methyltriethoxysilane.

In some embodiments, the adhesive catalyst is a titanate-based organometallic catalyst, preferably selected from at least one of isopropyl titanate, n-butyl titanate, poly(n-butyl titanate) and isooctyl titanate.

In some embodiments, the solvent is a mixed solvent of solvent A and solvent B, wherein solvent A is isopropanol and solvent B is xylene and/or acetone. The weight ratio of solvent A to solvent B is 1:(1 to 2), preferably 1:(1.2 to 1.6).

The fifth aspect of the present disclosure provides a method for preparing a silicone sealant primer, comprising the following steps: adding a solvent, an adhesive promoter, and an adhesive catalyst to a modified silane coupling agent, and mixing them evenly to obtain a silicone sealant primer.

The structure of the modified silane coupling agent of the present disclosure contains functional groups such as nitrogen heterocycles, allyl groups, and silicon oxygen groups. In high-humidity environments, the nitrogen heterocycles are easily hydrolyzed to form secondary amino silanes, consuming some of the moisture on the substrate surface; while the simultaneously formed secondary amines further promote the hydrolysis of siloxanes into multiple silanols, exhibiting rapid reaction capabilities. Multiple silanols have good compatibility with the inorganic surface of the substrate, enabling rapid film formation in high-humidity environments; the allyl and secondary amino groups of the modified silane coupling agents react with the organic groups of silicone sealants to form chemical bonds, effectively improving the compatibility between the organic components in the silicone sealants and the inorganic substances on the substrate surface, thus achieving strong adhesive in low-temperature environments.

The preparation method of the modified silane coupling agent of the present disclosure involves reacting allyl chloropropyl dichlorosilane with a short chain alcohol to obtain allyl chloropropyl dialkoxysilane, and then reacting the allyl chloropropyl dialkoxysilane with liquid ammonia to obtain bis(allyl-dialkoxysilylpropyl) amine. The bis(allyl-dialkoxysilylpropyl) amine is subjected to dealcoholization and cyclization reaction to obtain the modified silane coupling agent. The synthesis process is simple and under mild reaction conditions, and it is suitable for large-scale production.

The silicone sealant primer of the present disclosure maintains high film-forming and adhesive strength in low-temperature and high-humidity environments, and has high reactivity and good initial adhesive; overcoming the problems of uneven film formation and localized non-adhesive caused by reduced interfacial chemical reaction activity and self-hydrolysis failure of silicone sealant primer in low-temperature and high-humidity environments, thereby reducing the limitations imposed by the construction environment on the practical application of silicone sealant primers. Furthermore, the isopropanol in silicone sealant primer can be miscible with water, which reduces the critical surface tension of substrates in high-humidity environments, enhances the compatibility with organic polymer materials, and thereby improves the bonding performance.

### DESCRIPTION OF THE EMBODIMENTS

The following will further illustrate the technical solutions of the present disclosure through specific embodiments. Technicians in this field should understand that the described embodiments are only intended to help understanding the present disclosure and should not be considered as specific limitations to the present disclosure.

Unless otherwise defined, all technical and scientific terms used in the present disclosure have the same meaning as those commonly understood by those skilled in the art to which the present disclosure belongs. The terms used in the description of the present disclosure are for the purpose of describing specific embodiments only and are not intended to limit the present disclosure.

A method for preparing a modified silane coupling agent, comprising the following steps:
(1) mix allyl chloropropyl dichlorosilane with a short chain alcohol, heat to 70° C. to 90° C. and reflux for 1 h to 2 h to obtain allyl chloropropyl dialkoxysilane (intermediate 1); the synthesis route of which is shown in Reaction I.

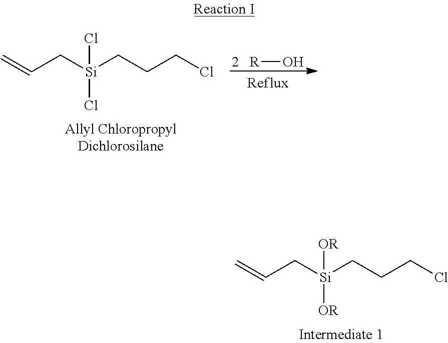

wherein, the short chain alcohol (R—OH) is a C1 to C4 saturated fatty alcohol.
(2) mix the allyl chloropropyl dialkoxysilane (intermediate 1) with liquid ammonia, introduce an inert gas, and conduct a reflux reaction under constant temperature at 60° C. to 70° C. for 1 h to 2 h to obtain bis(allyl-dialkoxysilylpropyl) amine (intermediate 2); the synthesis route of which is shown in Reaction II.

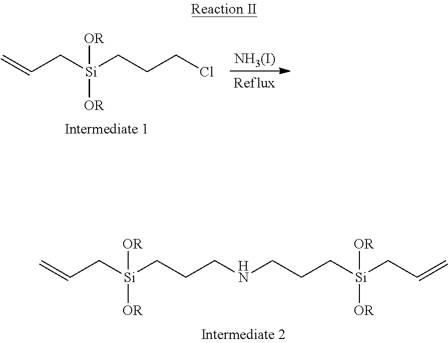

(3) add a catalyst to the bis(allyl-dialkoxysilylpropyl) amine (intermediate 2) and react at 70° C. to 80° C. for 2.5 h to 3.5 h to obtain a modified silane coupling agent, the synthesis route of which is shown in Reaction III.

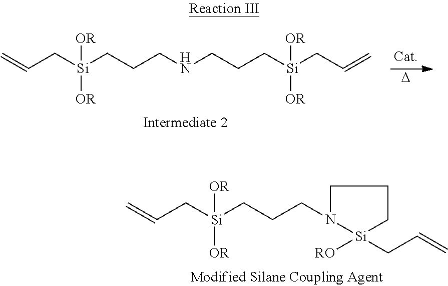

wherein, the catalyst consists of metallic nickel and an organic base, and the organic base is preferably sodium ethoxide.

The following are specific implementation embodiments.

### Embodiment 1

A method for preparing a modified silane coupling agent, comprising the following steps:
(1) 326 parts of allyl chloropropyl dichlorosilane were added into a four necked flask, and 160 parts of methanol were slowly added dropwise, then the mixture was stirred evenly and heated up to 80° C. and refluxed for 1 h. Nitrogen gas was then introduced to blow out the by-product hydrogen chloride gas to obtain allyl chloropropyl dialkoxysilane.
(2) After cooling down, the material was slowly added with 14 parts of liquid ammonia, stirred evenly, introduced with nitrogen gas, refluxed at 65° C. for 1 h, and then heated up to 85° C. for vacuum distillation purification to obtain bis(allyl-dialkoxysilylpropyl) amine.
(3) The bis(allyl-dialkoxysilylpropyl) amine was transferred into a three necked flask, added with 0.2 part of nickel powder and 0.02 part of sodium ethoxide. The mixture was stirred evenly, heated up to 75° C. for 3 h, then purified by vacuum distillation to obtain a modified silane coupling agent. Infrared spectroscopy analysis of the product revealed a strong peak at 875.3 cm−1 attributed to Si—N bond, a medium-strong peak at 1638.1 cm⁻¹ attributed to C═C bond, and a medium-strong peak at 1046.6 cm⁻¹ attributed to Si—O—C bond, and no bimodal attributed to N—H bond; therefore, the structural formula of the modified silane coupling agent is shown as follows:

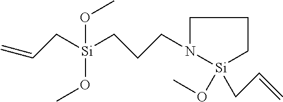 [SMILES: C=CC[Si](CCCN1CCC[Si]1(CC=C)OC)(OC)OC]

A silicone sealant primer, comprising following raw materials in parts by weight:

| | |
|---|---|
| modified silane coupling agent | 62 parts, |
| adhesive promoter | 13.6 parts, |
| adhesive catalyst | 19.9 parts, |
| solvent | 90 parts. |

Wherein the adhesive promoter was methyltrimethoxysilane, the adhesive catalyst was isopropyl titanate, and the solvent was a mixture of isopropanol and xylene in a mass ratio of 1:1.2.

The preparation method of the silicone sealant primer comprised the following steps: the above-synthesized modified silane coupling agent was sequentially added with a solvent, an adhesive promoter, and an adhesive catalyst, and then stirred evenly to obtain a silicone sealant primer, which was then sealed and stored.

### Embodiment 2

A method for preparing a modified silane coupling agent, comprising the following steps:
(1) 326 parts of allyl chloropropyl dichlorosilane were added into a four necked flask. and 160 parts of methanol were slowly added dropwise, then the mixture was stirred evenly and heated up to 70° C. and refluxed for 1 h. Nitrogen gas was then introduced to blow out the by-product hydrogen chloride gas to obtain allyl chloropropyl dialkoxysilane.
(2) After cooling down, the material was slowly added with 23.8 parts of liquid ammonia, stirred evenly, introduced with nitrogen gas, refluxed at 60° C. for 1 h, and then heated up to 70° C. for vacuum distillation purification to obtain bis(allyl-dialkoxysilylpropyl) amine.
(3) The bis(allyl-dialkoxysilylpropyl) amine was transferred into a three necked flask, added with 0.2 part of nickel powder and 0.02 part of sodium ethoxide. The mixture was stirred evenly, heated up to 70° C. for 3 h, then purified by vacuum distillation to obtain a modified silane coupling agent.

A silicone sealant primer, comprises following raw materials in parts by weight:

| | |
|---|---|
| modified silane coupling agent | 62 parts, |
| adhesive promoter | 17.8 parts, |
| adhesive catalyst | 23.8 parts, |
| solvent | 90 parts. |

Wherein the adhesive promoter was methyltriethoxysilane, the adhesive catalyst was n-butyl titanate, and the solvent was a mixture of isopropanol and acetone in a mass ratio of 1:1.6.

The preparation method of the silicone sealant primer comprised the following steps: the above-synthesized modified silane coupling agent was sequentially added with a solvent, an adhesive promoter, and an adhesive catalyst, and then stirred evenly to obtain a silicone sealant primer, which was then sealed and stored.

### Embodiment 3

A method for preparing a modified silane coupling agent, comprising the following steps:
(1) 326 parts of allyl chloropropyl dichlorosilane were added into a four necked flask. 239 parts of ethanol were slowly added dropwise, then the mixture was stirred and heated up to 90° C. and refluxed for 1 h. Nitrogen gas was then introduced to blow out the by-product hydrogen chloride gas to obtain allyl chloropropyl dialkoxysilane.
(2) After cooling down, the material was slowly added with 16 parts of liquid ammonia, stirred evenly, introduced with nitrogen gas, refluxed at 70° C. for 1 h, and then heated up to 100° C. for vacuum distillation purification to obtain bis(allyl-dialkoxysilylpropyl) amine.
(3) The bis(allyl-dialkoxysilylpropyl) amine was transferred into a three necked flask, added with 0.1 part of nickel powder and 0.005 part of sodium ethoxide. The mixture was stirred evenly, heated up to 80° C. for 3 h, then purified by vacuum distillation to obtain a modified silane coupling agent. Infrared spectroscopy analysis of the product revealed a strong peak at 871.5 cm⁻¹ attributed to Si—N bond, a medium-strong peak at 1640.4 cm⁻¹ attributed to C═C bond, a medium-strong peak at 1048.4 cm⁻¹ attributed to Si—O—C bond, and weak double peaks at 2975.8 cm⁻¹ and 2927.2 cm⁻¹ belonging to N—H bond. Therefore, the structural formula of the modified silane coupling agent is shown as follows:

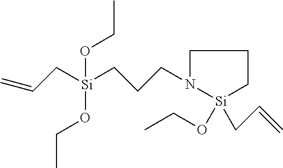 [SMILES: C=CC[Si](CCCN1CCC[Si]1(CC=C)OCC)(OCC)OCC]

A silicone sealant primer, comprising following raw materials in parts by weight:

| | |
|---|---|
| modified silane coupling agent | 68 parts, |
| adhesive promoter | 17.8 parts, |
| adhesive catalyst | 39.5 parts, |
| solvent | 125 parts. |

Wherein, the adhesive promoter was methyltriethoxysilane, the adhesive catalyst was Tert-butyl titanate, and the solvent was a mixture of isopropanol and xylene in a mass ratio of 1:1.4.

The preparation method of the silicone sealant primer comprised the following steps: the above-synthesized modified silane coupling agent was sequentially added with a solvent, an adhesive promoter, and an adhesive catalyst, and then stirred evenly to obtain a silicone sealant primer, which was then sealed and stored.

### Embodiment 4

A silicone sealant primer, comprising following raw materials in parts by weight:

| | |
|---|---|
| modified silane coupling agent | 62 parts, |
| adhesive promoter | 9.5 parts, |
| adhesive catalyst | 14.2 parts, |
| solvent | 90 parts. |

Wherein, the modified silane coupling agent was the same as the modified silane coupling agent in Embodiment 1;

The adhesive promoter was methyltrimethoxysilane, the adhesive catalyst was isopropyl titanate, and the solvent was a mixture of isopropanol and xylene in a mass ratio of 1:1.4.

The preparation method of the silicone sealant primer comprised the following steps: the above-synthesized modified silane coupling agent was sequentially added with a solvent, an adhesive promoter, and an adhesive catalyst, and then stirred evenly to obtain a silicone sealant primer, which was then sealed and stored.

### Embodiment 5

A silicone sealant primer, comprising following raw materials in parts by weight:

| | |
|---|---|
| modified silane coupling agent | 76 parts, |
| adhesive promoter | 13.6 parts, |
| adhesive catalyst | 25 parts, |
| solvent | 159 parts. |

Wherein, the modified silane coupling agent was the same as the modified silane coupling agent in Embodiment 3;

The adhesive promoter was methyltrimethoxysilane, the adhesive catalyst was poly(n-butyl polytitanate), and the solvent was xylene.

The preparation method of the silicone sealant primer comprised the following steps: the above-synthesized modified silane coupling agent was sequentially added with a solvent, an adhesive promoter, and an adhesive catalyst, and then stirred evenly to obtain a silicone sealant primer, which was then sealed and stored.

### Comparative Embodiment 1

The difference between the silicone sealant primer provided in this comparative embodiment and that in Embodiment 1 was that: the silicone sealant primer in this contrastive embodiment comprised following raw materials in parts by weight:

| | |
|---|---|
| modified silane coupling agent | 31 parts, |
| adhesive promoter | 13.6 parts, |
| adhesive catalyst | 19.9 parts, |
| solvent | 90 parts. |

The raw material components and preparation method of the silicone sealant primer were the same as those in Embodiment 1.

### Comparative Embodiment 2

The difference between the silicone sealant primer provided in this Comparative embodiment and that in Embodiment 1 was that: the silane coupling agent used in this Comparative embodiment was 3-aminopropyltrimethoxysilane.

The amounts of raw material components used in Embodiments 1 to 5 and Comparative embodiments 1 to 2 were shown in Table 1, in terms of parts by weight.

TABLE 1
Amounts of Raw Material Components Used
in Embodiments and Comparative Embodiments

| | Silane | Adhesive | Adhesive | |
|---|---|---|---|---|
| Embodiments | coupling agent | promoter | catalyst | Solvent |
| Embodiments 1 | 62 | 13.6 | 19.9 | 90 |
| Embodiments 2 | 62 | 17.8 | 23.8 | 90 |
| Embodiments 3 | 68 | 17.8 | 39.5 | 125 |
| Embodiments 4 | 62 | 9.5 | 14.2 | 90 |
| Embodiments 5 | 76 | 13.6 | 25 | 159 |
| Comparative | 31 | 13.6 | 19.9 | 90 |
| Embodiment 1 | | | | |
| Comparative | 36 | 13.6 | 19.9 | 90 |
| Embodiment 2 | | | | |

### Performance Testing

The silicone sealant primer solutions prepared in Embodiments 1 to 5 and Comparative Embodiment 1 to 2 were subjected to adhesive tests on different substrates.

Method: a silicone sealant primer sample was placed in a constant temperature and humidity chamber (temperature 10° C.±0.2° C., humidity 85%±5%) for 1 d. After low-temperature and high-humidity treatment, the sample was taken out and applied to a test substrate. After drying for 5 minutes, a two-component dealcoholized silicone structural sealant (Guangzhou Baiyun Chemical) was applied. After application, the sample was placed back into a constant temperature and humidity chamber (temperature 10° C.±0.2° C., humidity 85%±5%) for low-temperature curing for 20 h, and then the sample was taken out and subjected to room-temperature peeling test. As a control experiment, a two-component dealcoholized silicone sealant was applied directly without using a silicone sealant primer. The test results were shown in Table 2.

TABLE 2
Test Results of Sealant adhesive to Various Substrates
under Low-temperature and High-humidity

| | Cohesive failure/CF | | | |
|---|---|---|---|---|
| | Fluorocarbon | Powder | | |
| | coated | coated | Stainless | Galvanized |
| Substrate | aluminum | aluminum | steel | sheet |
| Embodiment 1 | 100% CF | 100% CF | 100% CF | 100% CF |
| Embodiment 2 | 80% CF | 80% CF | 80% CF | 85% CF |
| Embodiment 3 | 75% CF | 75% CF | 80% CF | 80% CF |
| Embodiment 4 | 85% CF | 85% CF | 90% CF | 90% CF |
| Embodiment 5 | 65% CF | 70% CF | 70% CF | 70% CF |
| Comparative | 60% CF | 60% CF | 65% CF | 60% CF |
| Embodiment1 | | | | |
| Comparative | 50% CF | 50% CF | 55% CF | 55% CF |
| Embodiment2 | | | | |
| Control | 0% CF | 0% CF | 10% CF | 10% CF |

As shown in Table 2, compared with the control embodiment without primer, the cohesive failure values of Embodiments 1 to 5 and Comparative Embodiment 1 to 2 were higher, indicating that the use of silicone sealant primer significantly improved the adhesive of silicone sealant in low-temperature and high-humidity environments. In Embodiment 1, the sealant showed 100% cohesive failure on different metal substrates, indicating extremely high bonding strength between the sealant and the metal substrate, demonstrating the excellent low-temperature/high-humidity adhesive of the silicone sealant primer. Compared with Embodiment 1, the cohesive failure area of in Embodiments 2 and 3 decreased to some extent, and the film formation rate of the primer slowed down. Due to the decrease in the purity of the modified silane coupling agent during the synthesis process, the reaction activity decreased, resulting in reduced bonding strength under extreme conditions.

From Comparing Embodiment 1 and Embodiment 4, it can be seen that an appropriate amount of adhesive promoter and adhesive catalyst in the primer solution was beneficial for improving the adhesive of the primer. In Embodiment 5, the primer solution did not contain isopropanol, resulting in small areas of dotted non-adhesive in the experimental sample, which was caused by poor compatibility between the coated primer solution and the substrate.

The content of the silane coupling agent in Comparative Embodiment 1 was relatively low, resulting in a slow film formation rate of the primer and large area of non-adhesive, indicating that the appropriate amount of modified silane coupling agent had a significant impact on the interfacial water resistance and low-temperature initial bonding speed of the primer. In Comparative Embodiment 2, 3-aminopropyltrimethoxysilane was used as the silane coupling agent, which had less cohesive failure. The film formation rate and initial bonding rate of the primer solution were too slow, indicating that conventional silane coupling agents failed to achieve strong adhesive in low-temperature and high-humidity environments.

The embodiments above merely express several implementations of the present disclosure. The descriptions of the embodiments are relatively specific and detailed, but may not therefore be construed as the limitation on the patent scope of the present disclosure. It should be noted that a person of ordinary skill in the art may further make several variations and improvements without departing from the concept of the present disclosure. These variations and improvements all fall within the protection scope of the present disclosure. Therefore, the patent protection scope of the present disclosure shall be defined by the appended claims.

What is claimed is:

1. A modified silane coupling agent, with following structural formula: 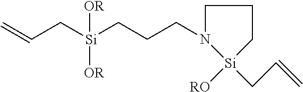
wherein, R is C1 to C4 alkyl.

2. The modified silane coupling agent according to claim 1, wherein R is methyl or ethyl.

3. A method for preparing the modified silane coupling agent according to claim 1, comprising the following steps:
an allyl chloropropyl dialkoxysilane is obtained through an alcohol substitution reaction between allyl chloropropyl dichlorosilane and a short-chain alcohol;
a bis(allyl-dialkoxysilylpropyl) amine is obtained through an amino substitution reaction between the allyl chloropropyl dialkoxysilane and liquid ammonia;
the modified silane coupling agent is obtained through a dealcoholization and cyclization reaction of the bis(allyl-dialkoxysilylpropyl) amine under the action of a catalyst;
the short-chain alcohol is selected from C1 to C4 saturated fatty alcohols.

4. The method for preparing the modified silane coupling agent according to claim 3, wherein the catalyst consists of metal nickel and an organic base in a mass ratio of (8 to 22):1.

5. The method for preparing the modified silane coupling agent according to claim 4, wherein the organic base is sodium ethoxide.

6. The method for preparing the modified silane coupling agent according to claim 3, wherein the short-chain alcohol is selected from methanol or ethanol.

7. The method for preparing the modified silane coupling agent according to claim 3, wherein a molar ratio of the allyl chloropropyl dichlorosilane to the short-chain alcohol is 1:(2 to 5); and/or,
a molar ratio of the allyl chloropropyl dialkoxysilane to the liquid ammonia is 1:(0.5 to 3); and/or,
a mass ratio of the catalyst to the bis(allyl-dialkoxysilylpropyl) amine is (0.001 to 0.01): 1.

8. The method for preparing the modified silane coupling agent according to claim 7, wherein the molar ratio of the allyl chloropropyl dichlorosilane to the short-chain alcohol is 1:(3 to 3.8); and/or,
the molar ratio of the allyl chloropropyl dialkoxysilane to the liquid ammonia is 1:(0.5 to 1); and/or,
the mass ratio of the catalyst to the bis(allyl-dialkoxysilylpropyl) amine is (0.0017 to 0.007):1.

9. The method for preparing the modified silane coupling agent according to claim 3, comprising the following steps:
(1) mix the allyl chloropropyl dichlorosilane with the short-chain alcohol, heat to 70° C. to 90° C. and reflux for 1 h to 2 h to obtain the allyl chloropropyl dialkoxysilane;
(2) mix the allyl chloropropyl dialkoxysilane with the liquid ammonia, introduce an inert gas, and conduct a reflux reaction at a constant temperature of 60° C. to 70° C. for 1 h to 2 h to obtain the bis(allyl-dialkoxysilylpropyl) amine;
(3) add the catalyst to the bis(allyl-dialkoxysilylpropyl) amine and react at 70° C. to 80° C. for 2.5 h to 3.5 h to obtain the modified silane coupling agent.

10. A silicone sealant primer, comprising a modified silane coupling agent according to claim 1.

11. The silicone sealant primer according to claim 10, comprising following raw materials in parts by weight:

| | |
|---|---|
| modified silane coupling agent | 30 to 145 parts |
| adhesive promoter | 7 to 28 parts |
| adhesive catalyst | 10 to 76 parts |
| solven | 70 to 168 parts. |

12. The silicone sealant primer according to claim 11, comprising following raw materials in parts by weight:

| | |
|---|---|
| modified silane coupling agent | 60 to 78 parts |
| adhesive promoter | 12 to 20 parts |
| adhesive catalyst | 15 to 40 parts |
| solvent | 90 to 140 parts. |

13. The silicone sealant primer according to claim 12, comprising following raw materials in parts by weight:

| | |
|---|---|
| modified silane coupling agent | 60 to 64 parts |
| adhesive promoter | 12 to 16 parts |
| adhesive catalyst | 18 to 22 parts |
| solvent | 88 to 92 parts. |

14. The silicone sealant primer according to claim 11, wherein the adhesive promoter is selected from at least one of methyltrimethoxysilane and methyltriethoxysilane; and/or, the adhesive catalyst is a titanate ester organic metal catalyst; and/or, the solvent is a mixed solvent of a solvent A and a solvent B, wherein the solvent A is isopropanol and the solvent B is xylene and/or acetone, wherein a weight ratio of the solvent A to the solvent B is 1:(1 to 2).

15. The silicone sealant primer according to claim 14, wherein the adhesive catalyst is selected from at least one of isopropyl titanate, n-butyl titanate, poly(n-butyl polytitanate), and isooctyl titanate.

16. The silicone sealant primer according to claim 14, wherein the weight ratio of the solvent A to the solvent B is 1:(1.2 to 1.6).
